(19) United States
(12) Patent Application Publication
(10) Pub. No.: US 2023/0366699 A1
(43) Pub. Date: Nov. 16, 2023

(54) SENSOR-BASED MAP CORRECTION

(71) Applicant: QUALCOMM Incorporated, San Diego, CA (US)

(72) Inventors: Meghana BANDE, Secaucus, NJ (US); Jubin JOSE, Basking Ridge, NJ (US)

(21) Appl. No.: 18/310,927

(22) Filed: May 2, 2023

Related U.S. Application Data
(60) Provisional application No. 63/340,722, filed on May 11, 2022.

(51) Int. Cl. G01C 21/00

(52) U.S. Cl. CPC G01C 21/3859; G01C 21/3841

(57) ABSTRACT

Systems and techniques are described for processing one or more maps. For example, a method can include obtaining a first map of an environment in which the computing device is located and obtaining a second map of the environment based on sensor data from one or more sensors. The method can include comparing first one or more elements of the first map and second one or more elements of the second map. Each respective element of the first one or more elements corresponds to a respective element of the second one or more elements. The method can further include determining whether to use the first map or the second map for at least one navigation function based on comparing the first one or more elements of the first map with the second one or more elements of the second map.

### CROSS-REFERENCE TO RELATED APPLICATIONS

This application claims the benefit of U.S. Provisional Application No. 63/340,722, filed May 11, 2022, which is hereby incorporated by reference in its entirety and for all purposes.

### FIELD OF THE DISCLOSURE

Aspects of the disclosure relate generally to sensor-based map correction. For example, aspects of the disclosure are related to expanding coverage of an environment map (e.g., a High-Definition (HD) map) with sensor-based map correction.

### BACKGROUND OF THE DISCLOSURE

Digital maps can be used for navigation purposes, such as for autonomous driving, vehicle navigation, determination of driving alerts, among other applications. For example, an important task in vehicle-based systems (e.g., Advanced Driver Assistance Systems (ADAS) systems, Automated Driving (AD) systems, etc.) is creating a model or map with information about the road, such as lane boundaries, road boundaries, traffic signs, traffic lights, stop lines, and other items in the vicinity of the vehicle. In some cases, such information may be obtained from a pre-existing map, referred to as an HD map or Autonomous Driving (AD) map. A vehicle may then perform localization with respect to the map. Systems and techniques are needed for improving the quality and/or accuracy of such maps.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for processing one or more maps. According to at least one illustrative example, an apparatus is provided for processing one or more maps. The apparatus can include at least one memory, and at least one processor (e.g., configured in circuitry) coupled to the at least one memory. The at least one processor is configured to: obtain a first map of an environment in which the apparatus is located; obtain a second map of the environment based on sensor data from one or more sensors; compare first one or more elements of the first map and second one or more elements of the second map, each respective element of the first one or more elements corresponding to a respective element of the second one or more elements; and determine whether to use the first map or the second map for at least one navigation function based on comparing the first one or more elements of the first map with the second one or more elements of the second map.

In another illustrative example, a method is provided for processing one or more maps at a computing device (e.g., a computing device of a vehicle or other system or device). The method includes: obtaining a first map of an environment in which the computing device is located; obtaining a second map of the environment based on sensor data from one or more sensors; comparing first one or more elements of the first map and second one or more elements of the second map, each respective element of the first one or more elements corresponding to a respective element of the second one or more elements; and determining whether to use the first map or the second map for at least one navigation function based on comparing the first one or more elements of the first map with the second one or more elements of the second map.

In another illustrative example, a non-transitory computer-readable medium of a computing device is provided that has stored thereon instructions that, when executed by one or more processors, cause the one or more processors to: obtain a first map of an environment in which the computing device is located; obtain a second map of the environment based on sensor data from one or more sensors; compare first one or more elements of the first map and second one or more elements of the second map, each respective element of the first one or more elements corresponding to a respective element of the second one or more elements; and determine whether to use the first map or the second map for at least one navigation function based on comparing the first one or more elements of the first map with the second one or more elements of the second map.

In another illustrative example, an apparatus for processing one or more maps is provided including: means for obtaining a first map of an environment in which the apparatus is located; means for obtaining a second map of the environment based on sensor data from one or more sensors; means for comparing first one or more elements of the first map and second one or more elements of the second map, each respective element of the first one or more elements corresponding to a respective element of the second one or more elements; and means for determining whether to use the first map or the second map for at least one navigation function based on comparing the first one or more elements of the first map with the second one or more elements of the second map.

In some aspects, one or more of the apparatuses described herein is, is part of, or includes a vehicle (e.g., a computing device, component, and/or system of a vehicle), a mobile device (e.g., a mobile telephone or so-called “smart phone” or other mobile device), a wearable device (e.g., a network-connected watch, etc.), an extended reality device (e.g., a virtual reality (VR) device, an augmented reality (AR) device, or a mixed reality (MR) device), a personal computer, a laptop computer, a server computer, or other device. In some aspects, an apparatus includes a camera or multiple cameras for capturing one or more images. In some aspects, the apparatus includes a display for displaying one or more images, notifications, and/or other displayable data. In some aspects, the apparatus can include one or more sensors, such as one or more inertial sensors (e.g., one or more accelerometers, one or more gyroscopes, etc.), one or more Light Detection and Ranging (LIDAR) sensors, one or more radar sensors, any combination thereof, and/or other sensors. In some cases, the one or more sensors can be used for determining a position and/or pose of the apparatus, a state of the apparatuses, and/or for other purposes.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a diagram illustrating an example of an environment including multiple vehicles driving on a road, in accordance with some examples;

FIG. 2 is a block diagram illustrating an example of system for processing one or more maps of an environment surrounding a vehicle, in accordance with some examples;

FIG. 3 is a diagram illustrating an example of an environment including a vehicle driving on a road, in accordance with some examples;

FIG. 4 is a flowchart illustrating an example of a process for processing one or more maps using the techniques described herein, in accordance with some examples;

FIG. 5 is a block diagram of an exemplary computing device that may be used to implement some aspects of the technology described herein, in accordance with some examples.

### DETAILED DESCRIPTION

Certain aspects and embodiments of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects and embodiments described herein can be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides example embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes can be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously noted, digital maps can be used for various navigational purposes, such as for autonomous driving, vehicle navigation, determination of driving alerts, among other applications. For example, a key feature for vehicle-based systems (e.g., Advanced Driver Assistance Systems (ADAS) systems, Automated Driving (AD) systems, etc.) is the generation of a model or map with information associated with an environment surrounding the vehicle, such as the road, lane boundaries, road boundaries, traffic signs, traffic lights, stop lines, among others. In some cases, such information may be obtained from a pre-existing map, referred to herein as an environment map (e.g., an HD map or AD map). A vehicle can perform localization with respect to the environment map (e.g., to determine its location in world coordinates with respect to the map coordinates). For instance, such as for ADAS/AD systems, a vehicle may obtain an HD/AD map and may perform localization with respect to the HD/AD maps.

In some cases, sensor-based technologies (e.g., cameras, Light Detection and Ranging (LIDAR) sensors, radar sensors, inertial sensors, etc.) provide a good source of information in an environment surrounding a vehicle. For instance, information associated with the environment can be obtained from on-board sensors of a vehicle (e.g., cameras, LIDAR sensors, radar sensors, etc.). The sensor information can be used to generate a sensor-based map.

Obtaining a road model from environment maps (e.g., HD maps or AD) or from sensor-based maps/road models come with their own set of advantages and challenges. For example, environment maps (e.g., HD or AD maps) are often detailed maps that provide the location of lane and road boundaries, lane-center lines, traffic signs, among other objects with high accuracy. Such environment maps may provide semantic information that is useful for determining details in the environment (e.g., details associated with the road, etc.). Such environment maps may additionally or alternatively include additional localization layers that are helpful to accurately localize the vehicle on the environment map. While an environment map provides high quality coverage that is beyond a field-of-view (FOV) of any line-of-sight sensor (e.g., camera, LIDAR sensor, radar sensor, etc.), creating and maintaining such environment maps with high accuracy can be a challenge. If the accuracy requirements of environment maps (e.g., HD or AD maps) can be relaxed with respect to a vehicle-based system (e.g., an ADAS system and/or AD system), the need for such complex environment maps may be reduced (e.g., allowing for map crowdsourcing of map information) and the coverage of such environment maps (e.g., for ADAS functions, AD functions, etc.) can be significantly expanded. For example, re-painting of lanes on a road may cause the corresponding boundary location and the lane-widths to change, but the overall structure of road is unlikely to change.

As noted above, a sensor-based map or road model may be generated using information from one or more on-board sensors (e.g., sensors on a vehicle), such as cameras, LIDAR sensors, radar sensors, inertial sensors (e.g., one or more accelerometers, one or more gyroscopes, etc.), and/or other sensors. A sensor-based map may be expressed with respect to a vehicle body frame, such as the rear-center axle of the vehicle. Sensor-based maps accurately capture the current environment in the environment surrounding the vehicle (e.g., within a certain distance, such as 10 meters, 20 meters, 30 meters, 50 meters, etc.) based on a range and/or FOV of the sensor(s). For example, a distance from the vehicle to a left boundary or a lane width of a lane in which the vehicle is located may be determined with high accuracy using sensor-based map/model. In some cases, a sensor-based map/model may or may not include detailed semantic information and road connectivity information. For example, a sensor-based map or model may include information associated with an exit ramp (e.g., based on the one or more sensors having a FOV that includes the exit ramp), but may not include information for the curvature and exact geometry of the exit ramp. The range of such sensor(s) depends on the FOV of the sensors and thus may be limited or low, in which case the accuracy of such sensor-based maps degrades as a distance from the vehicle to objects in the environment increases. Such a degradation in quality relative to increased distance from the vehicle can result in limitations in usage of sensor-based maps (e.g., for navigation planning, etc.).

Given the trade-off between environment maps or models (e.g., HD or AD maps) and sensor-based maps or models, it would be beneficial to leverage both types of maps when performing one or more navigation functions (e.g., for autonomous driving, for ADAS applications, etc.). However, existing solutions use only one of the two types of maps or leverage the sensor-based road map/model to validate the environment map (e.g., HD map)-based road model on-the-fly.

Systems, apparatuses, processes (methods), and computer-readable media (collectively referred to as “systems and techniques”) are described herein that combine information from environment maps/road models (e.g., a High-Definition (HD) map or Autonomous Driving (AD) map) and sensor-based maps/road models. For example, the systems and techniques can provide sensor-based map or model correction using the information from the environment maps/road models and sensor-based maps.

In some aspects, the systems and techniques provide correction of an environment map (e.g., a High-Definition (HD) map or an Autonomous Driving (AD) map) based on information from a sensor-based map. For instance, the systems and techniques can compare the sensor-based map to the environment map. Based on the comparison, the systems and techniques can determine whether to update or correct the environment map using information from the sensor-based map or to use the sensor-based map for a given purpose (e.g., to make an autonomous driving decision, to generate and/or output an alert such as a lane change warning, etc.). The maps described herein can also be referred to as models or map models (e.g., an environment map model, an HD map model, a sensor-based map model, etc.).

In one illustrative aspect, an HD map (as an example of an environment map) after localization is compared with a sensor-based map. The comparison can be performed locally on a vehicle or remotely in a server-based system. In comparing the two maps, different elements (also referred to as components) in the HD-based model are compared to similar (or corresponding) elements in the sensor-based model to compute a difference between the similar or corresponding elements (e.g., a difference in a parameter weighted by a standard deviation). For instance, one or more elements of the HD map are compared to one or more corresponding elements of the sensor-based map. In one example, an element defining a road lane in the HD map and an element defining the same road lane in the sensor-based map are considered “corresponding elements” in the two maps.

If a difference between the HD map and the sensor-based map is greater than (or exceeds) a threshold (which can indicate that one or more elements are mismatched by a significant amount or that at least one element in the HD map is missing), then the sensor-based model is determined to be used for one or more navigation functions. However, if the difference is less than the threshold, the HD map is determined to be used for the one or more navigation functions. The one or more navigation functions may include an ADAS function, an autonomous driving decision, a lane change function (e.g., making a lane change, etc.), a vehicle overtake function (e.g., overtaking another vehicle), a stop function, a speed reduction function, a speed or velocity increase function (e.g., increasing speed or velocity), output of a notification or alert (e.g., a lane departure warning, a do-not-pass warning, etc.), any combination thereof, and/or other functions.

In some aspects, if the difference is less than the threshold, a correction may be determined for the HD map based on the difference. The computed correction may be determined per map element/component or to the entire HD Map. For example, the correction may include shifting one or more road lane elements of the HD map (that correspond to one or more road lanes in the environment surrounding the vehicle) by an amount determined by the difference between the one or more road lane elements of the HD map and one or more corresponding road lane elements of the sensor-based map. In another example, all elements in the HD map corresponding to road lanes may be shifted based on the difference. In some cases, the correction may be transmitted to a server configured to maintain, update, etc. the HD map (e.g., an HD map server). Additionally or alternatively, the correction to the HD map may be made locally on the vehicle in which the comparison is made (e.g., the vehicle may determine the difference between corresponding elements of the HD map and sensor-based map are below the threshold, and may make the correction the HD map based on the comparison). In some aspects, map information (e.g., information from multiple systems, such as multiple vehicles, servers, etc.) can be shared between systems (e.g., vehicles, servers, etc.) via crowdsourcing for optimal correction of HD maps. For example, in some cases, a system (e.g., a vehicle, a server, etc.) can share corrections of an HD map (e.g., per localization) with one or more other systems (e.g., one or more other vehicles, servers, etc.).

Aspects are described herein using vehicles as illustrative examples of moving objects. However, one of ordinary skill will appreciate the systems and related techniques described herein can be included in and performed by any other movable object, system, or device for generating or updated a map of an environment. Examples of other systems that can perform or that can include components for performing the techniques described herein include robotics systems, XR systems (e.g., AR systems, VR systems, MR systems, etc.), aviation systems, among others systems.

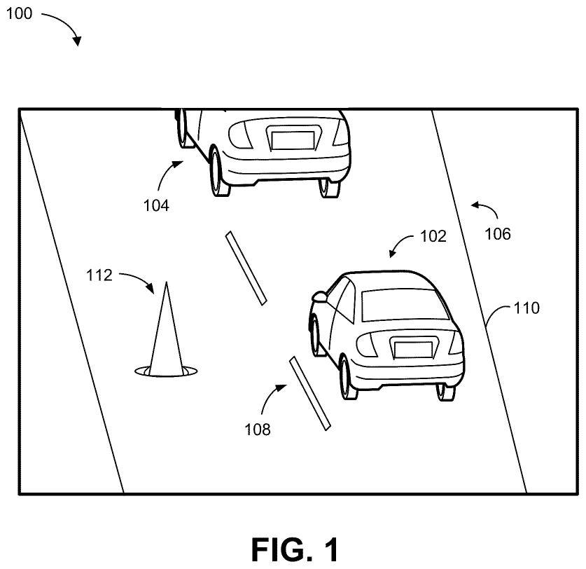

Various aspects of the application will be described with respect to the figures. FIG. 1 is a diagram illustrating an environment 100 including a vehicle 102 and a vehicle 104 driving on a road 106. Using on-board sensors and one or more maps of the environment 100 (e.g., an environment map such as an HD or AD map, a sensor-based map, etc.), each vehicle can track other vehicles and other objects in the environment 100. For instance, the vehicle 102 can track the vehicle 104 and any other objects in the environment in order to navigate the environment 100. For example, the vehicle 102 can determine a position and/or size of the vehicle 104, a location of lanes on the road 106 (e.g., a location of a lane marker 108), a location of one or more boundaries of the road 106 (e.g., road boundary 110), a location of objects in and around the road 106 (e.g., static object 112), etc. to determine when to perform a navigation function, such as slow down, speed up, change lanes, output a notification or alert, and/or perform some other function.

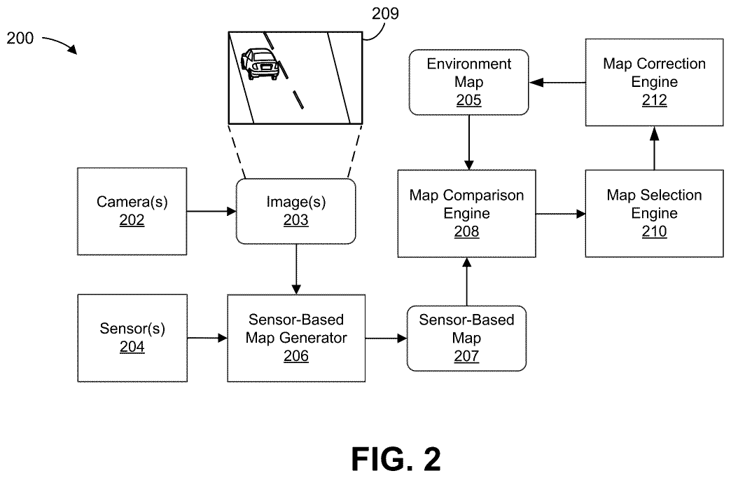

FIG. 2 is a block diagram illustrating an example of a system 200 for processing one or more maps of an environment surrounding a vehicle to determine which map to use for one or more navigation functions. As noted above, the one or more navigation functions may include an ADAS function, an autonomous driving decision, a lane change function (e.g., making a lane change, etc.), a vehicle overtake function (e.g., overtaking another vehicle), a stop function, a speed reduction function, a speed or velocity increase function (e.g., increasing speed or velocity), output of a notification or alert (e.g., a lane departure warning, a do-not-pass warning, etc.), any combination thereof, and/or other functions. In some cases, the system 200 can be included as a computing device or system in a vehicle. In one illustrative example, the system 200 can be included as part of an autonomous driving system included in an autonomous vehicle. In another illustrative example, the system 200 can be included as part of an ADAS system of a vehicle. While examples are described herein using vehicles for illustrative purposes, one of ordinary skill will appreciate the system 200 and related techniques described herein can be included in and performed by any other system or device.

The system 200 includes various components, including one or more cameras 202, one or more sensors 204, a sensor-based map generator 206, a map comparison engine 208, a map selection engine 210, and a map correction engine 212. The components of the system 200 can include software, hardware, or both. For example, in some implementations, the components of the system 200 can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the computing device implementing the system 200.

While the system 200 is shown to include certain components, one of ordinary skill will appreciate that the system 200 can include more or fewer components than those shown in FIG. 2. For example, the system 200 can include, or can be part of a computing device or object that includes, one or more input devices and one or more output devices (not shown). In some implementations, the system 200 may also include, or can be part of a computing device that includes, one or more memory devices (e.g., one or more random access memory (RAM) components, read-only memory (ROM) components, cache memory components, buffer components, database components, and/or other memory devices), one or more processing devices (e.g., one or more CPUs, GPUs, and/or other processing devices) in communication with and/or electrically connected to the one or more memory devices, one or more wireless interfaces (e.g., including one or more transceivers and a baseband processor for each wireless interface) for performing wireless communications, one or more wired interfaces (e.g., a serial interface such as a universal serial bus (USB) input, a lightening connector, and/or other wired interface) for performing communications over one or more hardwired connections, and/or other components that are not shown in FIG. 2.

As noted above, the system 200 can be implemented by and/or included in a computing device or other object. In some cases, multiple computing devices can be used to implement the system 200. For example, a computing device used to implement the system 200 can include a computer or multiple computers that are part of a device or object, such as a vehicle, a robotic device, a surveillance system, and/or any other computing device or object with the resource capabilities to perform the techniques described herein. In some implementations, the system 200 can be integrated with (e.g., integrated into the software, added as one or more plug-ins, included as one or more library functions, or otherwise integrated with) one or more software applications, such as an autonomous driving or navigation software application or suite of software applications. The one or more software applications can be installed on the computing device or object implementing the system 200.

The one or more cameras 202 of the system 200 can capture one or more images 203. In some cases, the one or more cameras 202 can include multiple cameras. For example, a vehicle including the system 200 can have a camera or multiple cameras on the front of the vehicle, a camera or multiple cameras on the back of the vehicle, a camera or multiple cameras on each side of the vehicle, and/or other cameras. In other examples where the system 200 is part of a robotic device, the robotic device can include multiple cameras on various parts of the robotics device. In another example, aviation device including the system 200 can include multiple cameras on different parts of the aviation device.

The one or more images 203 can include still images or video frames. The one or more images 203 each contain images of a scene. An example of an image 209 is shown in FIG. 2. The image 209 illustrates an example of an image captured by a camera of a vehicle (as an ego vehicle). When video frames are captured, the video frames can be part of one or more video sequences. In some cases, the images captured by the one or more cameras 202 can be stored in a storage device (not shown), and the one or more images 203 can be retrieved or otherwise obtained from the storage device. The one or more images 203 can be raster images composed of pixels (or voxels) optionally with a depth map, vector images composed of vectors or polygons, or a combination thereof. The images 203 may include one or more two-dimensional representations of a scene along one or more planes (e.g., a plane in a horizontal or x-direction and a plane in a vertical or y-direction), or one or more three dimensional representations of the scene.

The one or more sensors 204 can include LIDAR sensors, radar sensors, inertial sensors (e.g., one or more accelerometers, one or more gyroscopes, etc.), and/or other sensors. The one or more sensors 204 can output sensor data and the one or more cameras 202 can output the images 203 to the sensor-based map generator 206. The sensor-based map generator 206 can generate a sensor-based map 207 based on the one or more images 203 and the sensor data. The sensor-based map 207 includes defines elements or components of the environment surrounding the vehicle or other object in which the system 200 is implemented. For example, the sensor-based map 207 can include one or more elements defining a lane boundary, road boundary, etc. In some cases, the sensor-based map 207 defines each element or component with respect to a body frame of the vehicle or other object in which the system 200 is implemented (e.g., a vehicle body frame, such as the rear-center axle of the vehicle). A portion of the environment for which the sensor-based map 207 includes details can be based on the range or field-of-view (FOV) of the one or more cameras 202 and the one or more sensors 204.

The system 200 can obtain an environment map 205 (which may include an HD map, also referred to as AD map). In some cases, the system 200 can obtain a road model (referred to as an environment map-based road model) based on the environment map 205 after localizing in the environment map 205 (e.g., after determining a location of the system 200 or vehicle including the system 200 in world coordinates within the environment map 205). In some cases, the system 200 can determine a road model based on the sensor-based map 207, which can be referred to as a sensor map-based road model. Any example described herein with reference to the environment map 205 or the sensor-based map 207 can also apply to a model (e.g., a road model) defined or determined based on the environment map 205 and/or the sensor-based map 207.

To obtain an improved road model, the map comparison engine 208 can compare the environment map-based road model with the sensor map-based road model in the range of the sensor map-based road model. For example, in some cases, the information that is considered within the environment map 205 is limited by the range of the sensor-based map 207. If the difference between the environment map-based and sensor map-based road models is too high (e.g., greater than or exceeding a threshold difference) or an important element in the environment map 205 is missing, then the map selection engine 210 may determine that the entire environment map 205 (or the portion corresponding to the range of the sensor-based map 207) may be in error or invalid. In such cases, the map selection engine 210 may determine to directly use the sensor-based map 207 for the road model for performing one or more navigation functions (e.g., an ADAS function, and AD function, slow down, speed up, change lanes, output a notification or alert, and/or perform some other function). For example, if a boundary associated with the vehicle (e.g., a road boundary next to the vehicle) is missing in the environment map 205, the map selection engine 210 may switch to using the sensor-based map 207. However, if the difference in the road models is small enough (e.g., less than the threshold difference), the map selection engine 210 can continue to use the environment map-based road model. In some cases, if the difference in the road models is small enough (e.g., less than the threshold difference), the map correction engine 212 can determine or compute a correction to the environment map 205 using the sensor map-based road model.

In some aspects, the map comparison engine 208 may associate different elements in the environment map-based road model to similar elements (referred to as corresponding elements) in the sensor map-based road model. In some cases, the map comparison engine 208 may perform the association per element and/or jointly using geometry and other semantic information. For example, boundaries in the environment map 205 can be associated with the same or corresponding boundaries in the sensor-based map 207 using a lateral offset from the vehicle or other object (e.g., from the rear-axle), such as using the linear sum assignment problem. In some examples, semantic information of a boundary or other element (e.g., color, type, etc.) can be used to adapt the assignment problem (e.g., to adapt a cost used in the assignment problem).

For each associated element (e.g., each element of the environment map-based road model associated with a same or corresponding element of the sensor map-based road model), the map comparison engine 208 can identify one or more parameters and compare the difference in the parameters between the environment map-based road model and the sensor map-based road model. The one or more parameters can be a lateral difference or offset between map/model elements, an angular difference or offset between map/model elements, and/or other parameters.

Returning to FIG. 2, if the difference is too high (e.g., greater than a threshold difference, such as 10 centimeters (cm), 20 cm, 50 cm, 0.5 meters, etc.) or a particular element is missing, then the map comparison engine 208 can determine that the element is in error or invalid. The map selection engine 210 may then switch to the sensor map-based road model. If the difference in the parameter(s) between the maps is small enough (e.g., less than the threshold difference), the map correction engine 212 can determine or compute a correction, such as based on a difference in the parameters. For instance, the difference between the parameters can be used to correct the environment map 205 or the environment map-based road model (e.g., by moving a lane boundary of the map 205 or environment map-based road model by a certain translational distance, by an angular distance, etc.)

In some cases, information associated with an accuracy of the sensor map-based road model can be leveraged. For example, a covariance information of the sensor map-based road model can be used by the map correction engine 212 in computing the correction as a difference in the parameter weighted by the standard deviation. In some cases, the map correction engine 212 may determine or compute a final correction per element such as a lane boundary or averaged across different elements.

In some cases, the map correction engine 212 may apply the determined or computed map correction by applying the correction per map component or to the entire map (e.g., depending on the chosen correction). For example, if a lateral offset is computed as a correction that is to be applied per boundary, the lateral offset correction can be applied to the map per boundary. In another example, the map correction engine 212 can determine an average of the correction (e.g., an average of multiple or all lateral offset corrections) and can apply the average correction across multiple or all boundaries in the environment map 205 (or environment map-based model) that correspond to the sensor-based map 207 (or sensor map-based model).

In some aspects, the map correction engine 212 may apply a correction to the pose of the vehicle or other vehicle in which the system 200 is implemented. For example, if a correction parameter is chosen as a lateral offset and angle per boundary, then the weighted average lateral offset and angle correction across boundaries can be applied to the pose. In some cases, the map correction engine 212 may apply a correction to the pose of the vehicle or other vehicle in which the system 200 is implemented and may also apply the correction to certain map components. In some examples, the map correction engine 212 may use a weighted average of the lane boundary correction such that weights are chosen based on distance of the boundary from the vehicle. Such an example allows the effective road model to be much more accurate for elements next to vehicle, such as the lane boundary that the vehicle needs to cross.

In some aspects, the map correction engine 212 may apply a correction using a smoothness function, such as a Kalman filter or other type of smoothness or smoothing function. For instance, applying instantaneous correction to a pose of the vehicle or other object or to the environment map 205 can make it susceptible to large variance in changes across time. It can be important to ensure smoothness of the environment map 205 for a positive user experience (e.g., for a comfortable driving experience). The map correction engine 212 can use a smoothing function or filter (e.g., a Kalman filter) to ensure smoothness of the computed correction per component or the overall correction over time.

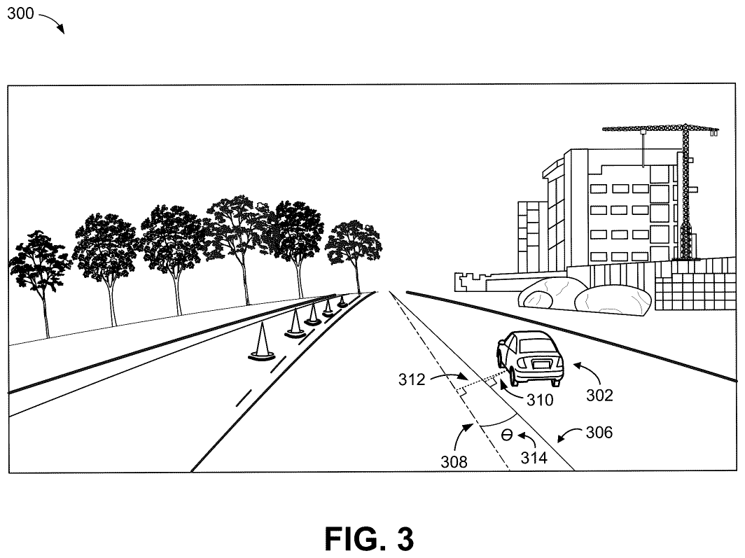

FIG. 3 is a diagram illustrating an example of an environment including a vehicle 302 driving on a road. The vehicle 302 can include the system 200 of FIG. 2. In one example, the map comparison engine 208 can identify a lateral distance 310 (as an example of a parameter) from the vehicle 302 to a road lane boundary 306 defined in the sensor-based map 207. The map comparison engine 208 can also identify a lateral distance 312 from the vehicle 302 to a road lane boundary 308 defined in the environment map 205. The map comparison engine 208 can compare the lateral distance 310 to the lateral distance 312 to determine a difference in the distances. The map correction engine 212 can use the determined difference to correct the road lane boundary 308 of the environment map 205. For instance, the map correction engine 212 can move the road lane boundary 308 by an amount equal to the determined difference. In another example, the map comparison engine 208 can determine differences between multiple road boundaries defined in the sensor-based map 207 and corresponding (or the same) road boundaries defined in the environment map 205. The map correction engine 212 can determine a representative distance based on the determined differences (e.g., an average of the differences) and can apply the representative distance to each of the road boundaries.

In another illustrative example, the map comparison engine 208 can identify an angular difference 314 (as another example of a parameter) between the road lane boundary 306 defined in the sensor-based map 207 and the road lane boundary 308 defined in the environment map 205. The map correction engine 212 can use the determined angular difference 314 to correct the road lane boundary 308 of the environment map 205. For instance, the map correction engine 212 can move the road lane boundary 308 by an angle equal to the determined angular difference 314. In another example, the map comparison engine 208 can determine angular differences between multiple road boundaries defined in the sensor-based map 207 and corresponding (or the same) road boundaries defined in the environment map 205. The map correction engine 212 can determine a representative angular difference based on the determined angular differences (e.g., an average angular difference) and can apply the representative angular difference to each of the road boundaries.

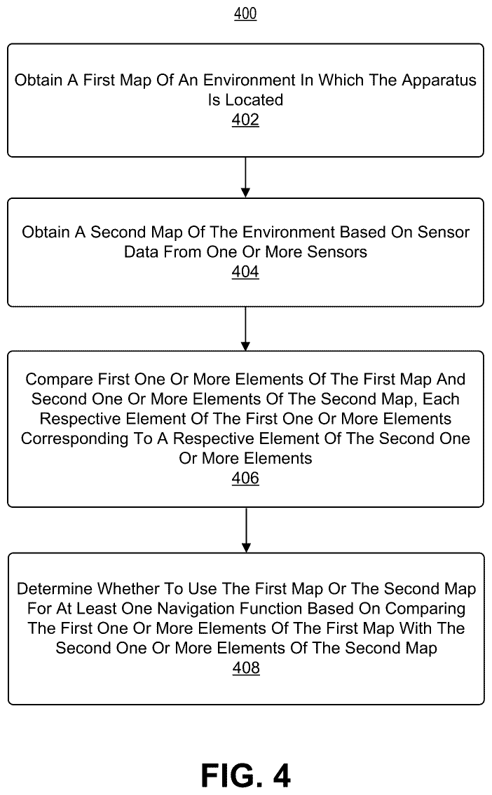

FIG. 4 is a flow diagram illustrating an example of a process 400 for processing one or more maps using techniques described herein. At block 402, the process 400 includes obtaining a first map of an environment in which the computing device is located. In some aspects, the first map is a high definition (HD) map. At block 404, the process 400 includes obtaining a second map of the environment based on sensor data from one or more sensors. In some aspects, obtaining the second map of the environment includes obtaining the sensor data from the one or more sensors and generating the second map based on the sensor data from the one or more sensors.

At block 406, the process 400 includes comparing first one or more elements of the first map and second one or more elements of the second map, each respective element of the first one or more elements corresponding to a respective element of the second one or more elements. In some aspects, comparing the first one or more elements of the first map with the second one or more elements of the second map includes determining at least one difference between the first one or more elements of the first map and the second one or more elements of the second map.

At block 408, the process 400 includes determining whether to use the first map or the second map for at least one navigation function based on comparing the first one or more elements of the first map with the second one or more elements of the second map. In some aspects, the process 400 includes performing the at least one navigation function using the first map or the second map. In some aspects, the computing device is part of a vehicle. For instance, the process 400 may include causing the vehicle to perform the at least one navigation function using the first map or the second map. In some cases, the at least one navigation function includes at least one of an Advanced Driver Assistance Systems (ADAS) function, an autonomous driving decision, a lane change function, a vehicle overtake function, a stop function, a speed reduction function, a velocity increase function, or an output of a notification

As noted above, in some aspects, comparing the first one or more elements of the first map with the second one or more elements of the second map includes determining the at least one difference between the first one or more elements of the first map and the second one or more elements of the second map. In some examples, the process 400 includes determining the at least one difference is less than a threshold difference and determining to use the first map for the at least one navigation function based on the at least one difference being less than the threshold difference. In such examples, the process 400 can include performing the at least one navigation function using the first map. In some cases, the process 400 includes determining at least one correction for the first map based on the at least one difference (e.g., based on determining the at least one difference is less than a threshold difference). In some aspects, the process 400 includes transmitting information associated with the at least one correction to a server configured to maintain the first map. In some aspects, the process 400 includes applying the at least one correction to the first map.

In some examples, the process 400 includes determining the at least one difference is greater than a threshold difference and determining to use the second map for the at least one navigation function based on the at least one difference being greater than the threshold difference. In such examples, the process 400 can include performing the at least one navigation function using the second map.

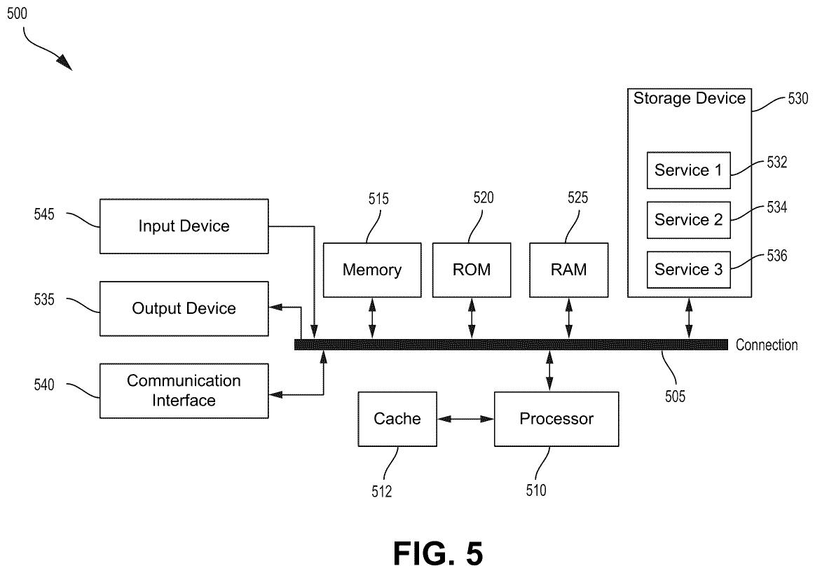

In some examples, the processes described herein (e.g., process 400 and/or other process described herein) may be performed by a computing device or apparatus (e.g., a vehicle computer system). In one example, the process 400 can be performed by the system 200 shown in FIG. 2. In another example, the process 400 can be performed by a computing device with the computing system 500 shown in FIG. 5. For instance, a vehicle with the computing architecture shown in FIG. 5 can include the components of system 200 shown in FIG. 2 and can implement the operations of process 400 shown in FIG. 4.

The computing device can include any suitable device, such as a vehicle or a computing device of a vehicle (e.g., a driver monitoring system (DMS) of a vehicle), a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including the process 400 and/or other process described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The process 400 is illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the process 400 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 5 is a diagram illustrating an example of a system for implementing certain aspects of the present technology. In particular, FIG. 5 illustrates an example of computing system 500, which can be for example any computing device making up internal computing system, a remote computing system, a camera, or any component thereof in which the components of the system are in communication with each other using connection 505. Connection 505 can be a physical connection using a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache 512 of high-speed memory connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms. In some instances, multimodal systems can enable a user to provide multiple types of input/output to communicate with computing system 500. Computing system 500 can include communications interface 540, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections.

As used herein, the term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted using any suitable means including memory sharing, message passing, token passing, network transmission, or the like.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the embodiments and examples provided herein. However, it will be understood by one of ordinary skill in the art that the embodiments may be practiced without these specific details. For clarity of explanation, in some instances the present technology may be presented as including individual functional blocks including functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Individual embodiments may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific embodiments thereof, but those skilled in the art will recognize that the application is not limited thereto. Thus, while illustrative embodiments of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, embodiments can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate embodiments, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the embodiments disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include the following:
Aspect 1. An apparatus for processing one or more maps, comprising: at least one memory; and at least one processor coupled to the at least one memory, the at least one processor configured to: obtain a first map of an environment in which the apparatus is located; obtain a second map of the environment based on sensor data from one or more sensors; compare first one or more elements of the first map and second one or more elements of the second map, each respective element of the first one or more elements corresponding to a respective element of the second one or more elements; and determine whether to use the first map or the second map for at least one navigation function based on comparing the first one or more elements of the first map with the second one or more elements of the second map.
Aspect 2. The apparatus of Aspect 1, wherein, to compare the first one or more elements of the first map with the second one or more elements of the second map, the at least one processor is configured to: determine at least one difference between the first one or more elements of the first map and the second one or more elements of the second map.
Aspect 3. The apparatus of Aspect 2, wherein the at least one processor is configured to: determine the at least one difference is less than a threshold difference; and determine to use the first map for the at least one navigation function based on the at least one difference being less than the threshold difference.
Aspect 4. The apparatus of any one of Aspects 2 or 3, wherein the at least one processor is configured to: determine at least one correction for the first map based on the at least one difference.
Aspect 5. The apparatus of Aspect 4, wherein the at least one processor is configured to: cause at least one transceiver to transmit information associated with the at least one correction to a server configured to maintain the first map.
Aspect 6. The apparatus of any one of Aspects 4 or 5, wherein the apparatus is a first vehicle or is part of the first vehicle, and wherein the at least one processor is configured to: cause at least one transceiver to transmit information associated with the at least one correction to a second vehicle.
Aspect 7. The apparatus of any one of Aspects 4 to 6, wherein the at least one processor is configured to: apply the at least one correction to the first map.
Aspect 8. The apparatus of any one of Aspects 4 to 7, wherein the at least one correction includes at least a first correction and a second correction, and wherein the at least one processor is configured to: apply the first correction to a first element of the first map; and apply the first correction to a second element of the first map.
Aspect 9. The apparatus of any one of Aspects 2 to 8, wherein the at least one processor is configured to: determine the at least one difference is greater than a threshold difference; and determine to use the second map for the at least one navigation function based on the at least one difference being greater than the threshold difference.
Aspect 10. The apparatus of any one of Aspects 1 to 9, wherein the first map is a high definition (HD) map.
Aspect 11. The apparatus of any one of Aspects 1 to 10, further comprising the one or more sensors, wherein, to obtain the second map of the environment, the at least one processor is configured to: obtain the sensor data from the one or more sensors; and generate the second map based on the sensor data from the one or more sensors.
Aspect 12. The apparatus of any one of Aspects 1 to 11, wherein the at least one processor is configured to: perform the at least one navigation function using the first map or the second map.
Aspect 13. The apparatus of any one of Aspects 1 to 12, wherein the apparatus is part of a vehicle.
Aspect 14. The apparatus of Aspect 13, wherein the at least one processor is configured to: cause the vehicle to perform the at least one navigation function using the first map or the second map.
Aspect 15. The apparatus of any one of Aspects 1 to 14, wherein the at least one navigation function includes at least one of an Advanced Driver Assistance Systems (ADAS) function, an autonomous driving decision, a lane change function, a vehicle overtake function, a stop function, a speed reduction function, a velocity increase function, or an output of a notification.
Aspect 16. A method of processing one or more maps at a computing device, comprising: obtaining a first map of an environment in which the computing device is located; obtaining a second map of the environment based on sensor data from one or more sensors; comparing first one or more elements of the first map and second one or more elements of the second map, each respective element of the first one or more elements corresponding to a respective element of the second one or more elements; and determining whether to use the first map or the second map for at least one navigation function based on comparing the first one or more elements of the first map with the second one or more elements of the second map.
Aspect 17. The method of Aspect 16, wherein comparing the first one or more elements of the first map with the second one or more elements of the second map comprises: determining at least one difference between the first one or more elements of the first map and the second one or more elements of the second map.
Aspect 18. The method of Aspect 17, further comprising: determining the at least one difference is less than a threshold difference; and determining to use the first map for the at least one navigation function based on the at least one difference being less than the threshold difference.
Aspect 19. The method of any one of Aspects 17 or 18, further comprising: determining at least one correction for the first map based on the at least one difference.
Aspect 20. The method of Aspect 19, further comprising: transmitting information associated with the at least one correction to a server configured to maintain the first map.
Aspect 21. The method of any one of Aspects 19 or 20, wherein the computing device is a first vehicle or is part of the first vehicle, and further comprising: transmitting information associated with the at least one correction to a second vehicle.
Aspect 22. The method of any one of Aspects 19 to 21, further comprising: applying the at least one correction to the first map.
Aspect 23. The method of any one of Aspects 19 to 22, wherein the at least one correction includes at least a first correction and a second correction, and further comprising: applying the first correction to a first element of the first map; and applying the first correction to a second element of the first map.
Aspect 24. The method of any one of Aspects 19 to 23, further comprising: determining the at least one difference is greater than a threshold difference; and determining to use the second map for the at least one navigation function based on the at least one difference being greater than the threshold difference.
Aspect 25. The method of any one of Aspects 16 to 24, wherein the first map is a high definition (HD) map.
Aspect 26. The method of any one of Aspects 16 to 25, wherein obtaining the second map of the environment comprises: obtaining the sensor data from the one or more sensors; and generating the second map based on the sensor data from the one or more sensors.
Aspect 27. The method of any one of Aspects 16 to 26, further comprising: performing the at least one navigation function using the first map or the second map.
Aspect 28. The method of any one of Aspects 16 to 27, wherein the computing device is part of a vehicle.
Aspect 29. The method of Aspect 28, further comprising: causing the vehicle to perform the at least one navigation function using the first map or the second map.
Aspect 30. The method of any one of Aspects 16 to 29, wherein the at least one navigation function includes at least one of an Advanced Driver Assistance Systems (ADAS) function, an autonomous driving decision, a lane change function, a vehicle overtake function, a stop function, a speed reduction function, a velocity increase function, or an output of a notification.
Aspect 31. A non-transitory computer-readable medium having stored thereon instructions that, when executed by one or more processors, cause the one or more processors to perform operations according to any of Aspects 16 to 30.
Aspect 32. An apparatus for processing one or more maps comprising one or more means for performing operations according to any of Aspects 16 to 30.

What is claimed is:

1. An apparatus for processing one or more maps, comprising:
at least one memory; and
at least one processor coupled to the at least one memory, the at least one processor configured to:
obtain a first map of an environment in which the apparatus is located;
obtain a second map of the environment based on sensor data from one or more sensors;
compare first one or more elements of the first map and second one or more elements of the second map, each respective element of the first one or more elements corresponding to a respective element of the second one or more elements; and
determine whether to use the first map or the second map for at least one navigation function based on comparing the first one or more elements of the first map with the second one or more elements of the second map.

2. The apparatus of claim 1, wherein, to compare the first one or more elements of the first map with the second one or more elements of the second map, the at least one processor is configured to:
determine at least one difference between the first one or more elements of the first map and the second one or more elements of the second map.

3. The apparatus of claim 2, wherein the at least one processor is configured to:
determine the at least one difference is less than a threshold difference; and
determine to use the first map for the at least one navigation function based on the at least one difference being less than the threshold difference.

4. The apparatus of claim 2, wherein the at least one processor is configured to:
determine at least one correction for the first map based on the at least one difference.

5. The apparatus of claim 4, wherein the at least one processor is configured to:
cause at least one transceiver to transmit information associated with the at least one correction to a server configured to maintain the first map.

6. The apparatus of claim 4, wherein the apparatus is a first vehicle or is part of the first vehicle, and wherein the at least one processor is configured to:
cause at least one transceiver to transmit information associated with the at least one correction to a second vehicle.

7. The apparatus of claim 4, wherein the at least one processor is configured to:
apply the at least one correction to the first map.

8. The apparatus of claim 4, wherein the at least one correction includes at least a first correction and a second correction, and wherein the at least one processor is configured to:
apply the first correction to a first element of the first map; and
apply the first correction to a second element of the first map.

9. The apparatus of claim 2, wherein the at least one processor is configured to:
determine the at least one difference is greater than a threshold difference; and
determine to use the second map for the at least one navigation function based on the at least one difference being greater than the threshold difference.

10. The apparatus of claim 1, wherein the first map is a high definition (HD) map.

11. The apparatus of claim 1, further comprising the one or more sensors, wherein, to obtain the second map of the environment, the at least one processor is configured to:
obtain the sensor data from the one or more sensors; and
generate the second map based on the sensor data from the one or more sensors.

12. The apparatus of claim 1, wherein the at least one processor is configured to:
perform the at least one navigation function using the first map or the second map.

13. The apparatus of claim 1, wherein the apparatus is part of a vehicle.

14. The apparatus of claim 13, wherein the at least one processor is configured to:
cause the vehicle to perform the at least one navigation function using the first map or the second map.

15. The apparatus of claim 1, wherein the at least one navigation function includes at least one of an Advanced Driver Assistance Systems (ADAS) function, an autonomous driving decision, a lane change function, a vehicle overtake function, a stop function, a speed reduction function, a velocity increase function, or an output of a notification.

16. A method of processing one or more maps at a computing device, comprising:
obtaining a first map of an environment in which the computing device is located;
obtaining a second map of the environment based on sensor data from one or more sensors;
comparing first one or more elements of the first map and second one or more elements of the second map, each respective element of the first one or more elements corresponding to a respective element of the second one or more elements; and
determining whether to use the first map or the second map for at least one navigation function based on comparing the first one or more elements of the first map with the second one or more elements of the second map.

17. The method of claim 16, wherein comparing the first one or more elements of the first map with the second one or more elements of the second map comprises:
determining at least one difference between the first one or more elements of the first map and the second one or more elements of the second map.

18. The method of claim 17, further comprising:
determining the at least one difference is less than a threshold difference; and
determining to use the first map for the at least one navigation function based on the at least one difference being less than the threshold difference.

19. The method of claim 17, further comprising:
determining at least one correction for the first map based on the at least one difference.

20. The method of claim 19, further comprising:
transmitting information associated with the at least one correction to a server configured to maintain the first map.

21. The method of claim 19, wherein the computing device is a first vehicle or is part of the first vehicle, and further comprising:
transmitting information associated with the at least one correction to a second vehicle.

22. The method of claim 19, further comprising:
applying the at least one correction to the first map.

23. The method of claim 19, wherein the at least one correction includes at least a first correction and a second correction, and further comprising:
applying the first correction to a first element of the first map; and
applying the first correction to a second element of the first map.

24. The method of claim 19, further comprising:
determining the at least one difference is greater than a threshold difference; and
determining to use the second map for the at least one navigation function based on the at least one difference being greater than the threshold difference.

25. The method of claim 16, wherein the first map is a high definition (HD) map.

26. The method of claim 16, wherein obtaining the second map of the environment comprises:
obtaining the sensor data from the one or more sensors; and
generating the second map based on the sensor data from the one or more sensors.

27. The method of claim 16, further comprising:
performing the at least one navigation function using the first map or the second map.

28. The method of claim 16, wherein the computing device is part of a vehicle.

29. The method of claim 28, further comprising:
causing the vehicle to perform the at least one navigation function using the first map or the second map.

30. The method of claim 16, wherein the at least one navigation function includes at least one of an Advanced Driver Assistance Systems (ADAS) function, an autonomous driving decision, a lane change function, a vehicle overtake function, a stop function, a speed reduction function, a velocity increase function, or an output of a notification.
